(19) United States
(12) Patent Application Publication
(10) Pub. No.: US 2014/0234587 A1
(43) Pub. Date: Aug. 21, 2014

(54) Methods of Producing Flat Top Dots on Flexographic Printing Plates, and Laminates Therefor

(71) Applicant: John P. Maneira, Alpharetta, GA (US)

(72) Inventor: John P. Maneira, Alpharetta, GA (US)

(73) Assignee: Chemence, Inc., Alpharetta, GA (US)

(21) Appl. No.: 13/770,195

(22) Filed: Feb. 19, 2013

(51) Int. Cl. B41C 1/00

(52) U.S. Cl. CPC B41C 1/003; B41C 1/00
USPC 428/195.1; 156/182; 156/246; 216/36

(57) ABSTRACT

Two methods using two respective laminates produce flexographic printing plates with flat top dots from sheet photopolymers. The methods use a preliminary laminate to isolate the photopolymer surface from the ambient air. A third method enables images to be transferred to non-porous surfaces.

### BACKGROUND OF INVENTION

1. Field of the Invention

This invention is in the field of printing, more specifically in transferring images for printing techniques, and still more specifically in the field of making flexographic printing plates with flat top dots. The invention is also in the field of transferring images from one surface to another.

2. Description of the Related Art

A common method of preparation of a simple flexographic (“flexo”) printing plate from a so-called analog sheet photopolymer (such as supplied by, for example, DuPont, Kodak, or Flint Group) currently involves the steps of (a) printing a black negative image on a white substrate; (b) photographing the negative image; (c) developing the film negative; (d) positioning the film negative on top of the sheet photopolymer in a special exposure unit; (e) placing a thin plastic vacuum sheet over the negative; (f) applying a vacuum to the laminate thus formed (vacuum sheet, negative, and sheet photopolymer); (g) exposing this laminate to actinic radiation through the negative for an amount of time sufficient to create a crosslinked polymerized image in the photopolymer; (h) removing the laminate from the unit and separating the vacuum sheet and negative from the exposed sheet photopolymer; and (i) mechanically removing the uncrosslinked photopolymer from the sheet with a solvent to develop a relief image.

The vacuum step (f) is critical in this process. If there are any pockets of air between the negative and the surface of the photopolymer, the UV light will be refracted by the interfaces between the air, the film and the photopolymer and the final image after exposure will be distorted. If the pockets of air are large enough, they can even lead to mechanical failure of the plate by creating thin spots in the photopolymer. Moreover, ambient oxygen in any air pockets in contact with surface of the photopolymer inhibits full curing of the photopolymer all the way to the photopolymer surface. (This is thought to be because oxygen in the air reacts with gases formed within the photopolymer layer during UV curing, the products of which slow the curing rate.) Provided the negative and vacuum sheet are skillfully placed, the vacuum system in the special exposure unit will remove a great majority (but not all) such pockets of air. The high vacuum capability of the special exposure unit is one reason the exposure unit is so expensive.

All of the above steps except perhaps (c) and (f) require human handling and make the entire process slow. For this reason, a method combining or eliminating some of these steps is called for to speed the process and permit a simpler and less expensive exposure unit to be used.

Another common method of preparing a flexo plate involves creating a negative image directly on the opaque-coated side, or thermal layer, of a so-called digital photopolymer sheet (also called computer-to-plate or CTP, such as supplied by, for example, DuPont, Kodak, or Flint Group) by ablating portions of the thermal layer using, for example, an IR laser. This technique has the advantage of eliminating the need for a film negative and the distortion effects of air bubbles trapped under the negative, but unless a vacuum sheet or a coating is applied on top of the ablated surface to keep air out during UV exposure, full curing of the photopolymer all the way to the surface is still inhibited. Further, in the case of CTP imaging, the image material itself can release water vapor under high vacuum, which can collect into pockets. Thus, no matter whether the image is applied in the form of a film negative or ablated into digital sheet photopolymer, small relief detail such as halftone dots do not have flat tops and cannot transfer ink with sufficiently sharp image edges onto the surface to be printed. It has also been determined that flexo plates with flat top dots last longer (endure more impressions) than rounded dots because they distribute the impact stress more evenly throughout the polymer. There is thus a need for methods of imaging photopolymer sheets which solve these problems.

Another art related to the instant invention is that of placing images on surfaces that cannot be run through a printer, such as walls, furniture, doors, and windows. The prior art includes painting, applique, stenciling and etching. All of these techniques are more or less skill, labor, and time intensive. There is a need for a rapid and less skill-intensive method.

### BRIEF DESCRIPTION OF THE INVENTION

The methods of the instant invention relate to printing. The first method is for transferring fine detail inkjet images onto analog photopolymer sheets to produce flexo plates with flat top dots. The second method relates to preventing photopolymer exposure to air during curing or formation of gas bubbles using digital flexo plate technology, again to produce flexo plates with flat top dots. These two methods eliminate the aforementioned problems with gas bubbles, reduce the number of steps required and the level of expertise necessary to execute them, produce flexo plates with better flat top dots, and produce final prints of higher quality, than achievable by current methods under the best of conditions. The third method of the invention provides a way to transfer printed images to non-porous surfaces that cannot be run through a printer, such as windows.

All of these methods begin by preparing a preliminary laminate of an inkjet-receptive emulsion/release coating (hereinafter referred to as a “release coating”) onto a plastic, e.g., polyester, backing sheet. Once the preliminary laminate is made, a protective film may be placed over the release coating for storage and handling, to be removed before use in the invented methods.

In the first method, a clear release coating is imaged and used to transfer its image to an analog photopolymer sheet by the application of a clear adhesive to the photopolymer sheet followed by application of the image side of the preliminary laminate to the adhesive. A first laminate of the instant invention is thus created. It is possible to get the same result, of course, by applying the adhesive to the image side of the preliminary laminate instead of the photopolymer sheet. The adhesive must be compatible with both the image material, the release coating, and the photopolymer to which the preliminary laminate is being affixed. The adhesive should be a fast self-curing resin that produces a stronger bond between the image material and the photopolymer surface than exists between the release coating and the backing sheet. Once the adhesive cures, the backing sheet is peeled off the release coating and image material. The sheet photopolymer so imaged is then exposed to actinic radiation (without the need for vacuum) and processed normally.

In the second method of the instant invention, involving a pre-imaged photopolymer sheet such as a digital plate, the adhesive is applied to the imaged photopolymer, followed by application of the preliminary laminate to the adhesive. A second laminate of the instant invention is thus created. As with the aforementioned first method, it is possible to get the same result by applying the adhesive to the preliminary laminate instead of the photopolymer sheet. Again, the adhesive must be compatible with both the image material and the non-porous surface to which the preliminary laminate is being affixed, and should be a fast self-curing resin that produces a stronger bond between the release coating and the non-porous surface than exists between the release coating and the backing sheet. Once the adhesive cures, the backing sheet is peeled off the release coating and image material. The sheet photopolymer is then exposed to actinic radiation (without the need for vacuum) and processed normally.

In the third method of the invention, the backing sheet of the preliminary laminate need not be transparent. A clear release coating is applied to the backing sheet to form the preliminary laminate, and the image is printed (or stamped or drawn) on the release coating. A clear adhesive layer is spread on the non-porous surface, and the image side of the preliminary laminate is pressed into the adhesive to form a third laminate of the instant invention. The adhesive should be a fast self-curing resin that produces a stronger bond between the release coating and the non-porous surface than exists between the release coating and the backing sheet. After the adhesive cures, the backing sheet is peeled off, leaving the image on the non-porous surface.

### BRIEF DESCRIPTION OF THE DRAWINGS

FIG. 1 depicts in cross-section a prior art method of making a flexographic printing plate from an image negative using a sheet photopolymer.

FIG. 2 is a magnified cross-sectional view of an analog photopolymer sheet exposed according to the prior art in FIG. 1 under a good vacuum.

FIG. 3 is a magnified cross-sectional view of a digital photopolymer sheet exposed according to other prior art.

FIG. 4 is a magnified cross-sectional view of a digital photopolymer sheet exposed according to other prior art under a good vacuum.

FIG. 5 is a magnified cross-sectional view of the preliminary laminate used in all three of the methods of the invention.

FIG. 6 is a magnified perspective view of the preliminary laminate being inkjet printed in accordance with the first method of the invention.

FIG. 7 shows in magnified cross-section the printed preliminary laminate being applied to a photopolymer sheet for production of a flexo plate in accordance with the first method of the invention to form the first embodiment laminate of the invention.

FIG. 8 shows in magnified cross-section the backing sheet being peeled off the unexposed sheet photopolymer in accordance with the first method of the invention.

FIG. 9 is a magnified cross-section of the preliminary laminate being applied to a digitally-imaged sheet photopolymer in accordance with the second method of the invention to form the second embodiment laminate of the invention.

FIG. 10 shows in magnified cross-section the photopolymer sheet prepared according to the first method of the invention being exposed to actinic radiation.

FIG. 11 is a magnified cross-sectional view of an analog photopolymer sheet exposed according to the first method of the invention.

FIG. 12 is a magnified cross-sectional view of a digital photopolymer sheet exposed according to the second method of the invention.

FIG. 13 depicts in magnified cross-section the finished flexo plate after removal of soluble materials in accordance with the first and second methods of the invention.

FIG. 14 depicts in magnified cross-section an example of the application of a printed preliminary laminate to transfer an inkjet image to glass in accordance with the third method of the invention.

FIG. 15 depicts in magnified cross-section removal of the backing sheet from the inkjet image on glass in accordance with the third method of the invention.

### DETAILED DESCRIPTION OF THE INVENTION

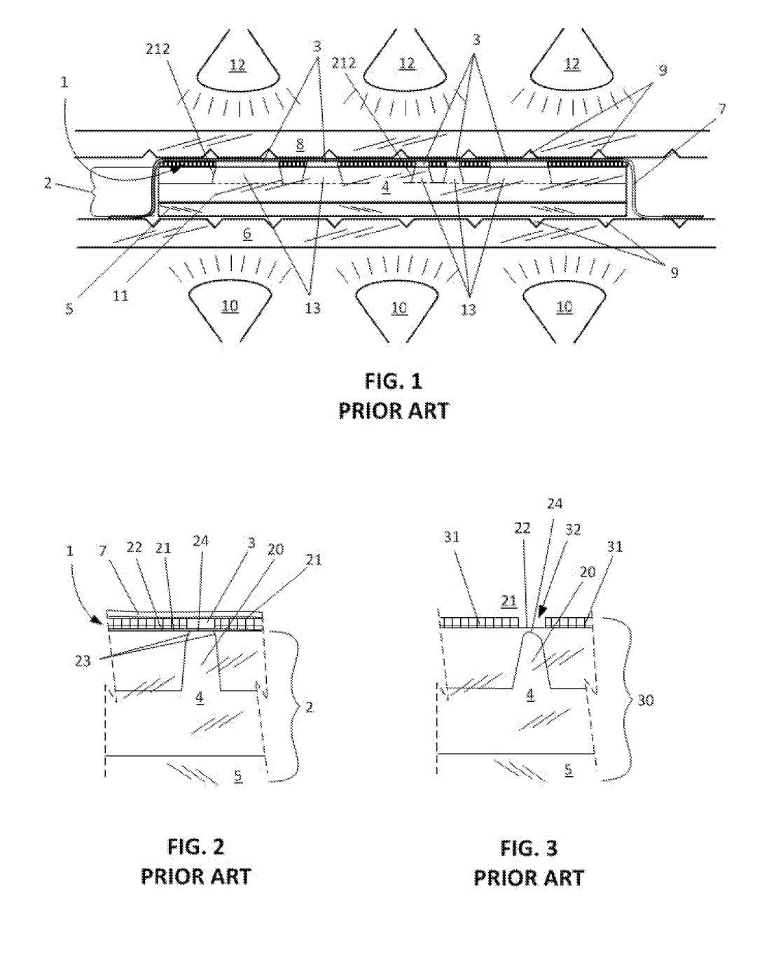

Referring now to the drawings, which are not to scale, and in which like reference characters refer to like elements among the drawings, FIG. 1 depicts in magnified cross-section a prior art method of making a flexographic printing plate from a photographic film negative 1 and a so-called analog sheet photopolymer 2. The film negative 1 consists of a plurality of black areas opaque to actinic radiation. Henceforth in this description, the actinic radiation will be exemplified by, and referred to as, UV (ultraviolet) light, and the sheet photopolymers mentioned will be of the types that are curable by UV light, but without the intention to limit the invention or its use to UV and photopolymers sensitive to UV.

Again referring to FIG. 1, transparent areas 3 between the black areas in the film negative 1 allow UV light to pass through. Not uncommonly, a transparent area may be as small as a single dot in a halftone image, perhaps corresponding to a single pixel of a digital image or a single (missing) droplet from an inkjet printer. The sheet photopolymer 2 consists of a layer of photosensitive copolymer 4 bonded to a transparent polyester substrate 5. The combination of film negative 1 and sheet photopolymer 2 is placed on a transparent bottom glass 6 in a special exposure machine, and a transparent vacuum sheet 7 is placed over the negative. A top glass 8 is then lowered down on top of the vacuum sheet 7, and a vacuum is applied to entire sandwich by withdrawing air through a network of grooves 9. Once the air is withdrawn to a hard vacuum, lower UV lights 10 are turned on for a length of time sufficient to cure a floor area 11 within the copolymer layer 4 of the desired thickness on top of the substrate 5. The upper UV lights 12 are then turned on to shine through the transparent areas 3 in the image layer 1. The lights are on for a length of time sufficient to expose areas within the remainder of the copolymer 4 and create a substantially vertical relief pattern 13. The exposed sheet photopolymer 2 is then removed from the apparatus and developed into a flexo plate by known washing and/or scrubbing techniques to remove any unpolymerized photopolymer.

Making a flexo plate from CTP technology looks similar to FIG. 1, with the exception that the opaque image is formed directly on the upper surface of the copolymer 4, so the thin air space between the negative and the copolymer surface is eliminated. Nevertheless, some air will still exist between the vacuum sheet 7 and the copolymer surface depending on the intensity of the vacuum and how carefully the vacuum sheet is applied to eliminate air bubbles. Some water vapor bubbles may appear anyway if there is any moisture in the opaque image material.

FIG. 2 is a more highly magnified cross-sectional view of a portion of an analog photopolymer sheet 2 exposed and developed as described in FIG. 1 under a good vacuum as taught in the prior art. It shows a single relief dot 20 formed under a one pixel wide transparent area 3 in a film negative 1. Even under good vacuum there will be some gas 21 (predominantly air) beneath the vacuum sheet 7 and underneath the negative 1 in contact with the surface 22 of the copolymer 4. As a result, the shoulders 23 of the top 24 of the dot 20 are slightly rounded. This is believed to be caused by the presence of oxygen at the surface 22 interfering with crosslinking of the photopolymer. The printed image of this dot will not be sharp.

FIG. 3 is the same view of a relief dot 20 produced using a pre-imaged digital (CTP) photopolymer sheet 30 and no vacuum sheet. A digital photopolymer sheet 30 differs from an analog sheet 2 in that it has not only a clear substrate layer 5 and a photosensitive copolymer layer 4, but also an opaque image layer 31. The image layer 31 has been ablated with an IR laser to produce a clear etched area 32 through which UV light can pass to create a positive relief image in the flexo plate. Without any covering of the imaged sheet 30, gas 21 in the form of oxygen in the ambient air can come into contact freely with the surface 22 of the copolymer 4 during UV exposure. The top 24 of the dot 20 is even more rounded than in FIG. 2 and may not even reach the surface 22 of the copolymer layer 4. The printed image of this dot oftentimes appears as a tiny squiggle where the dot should be.

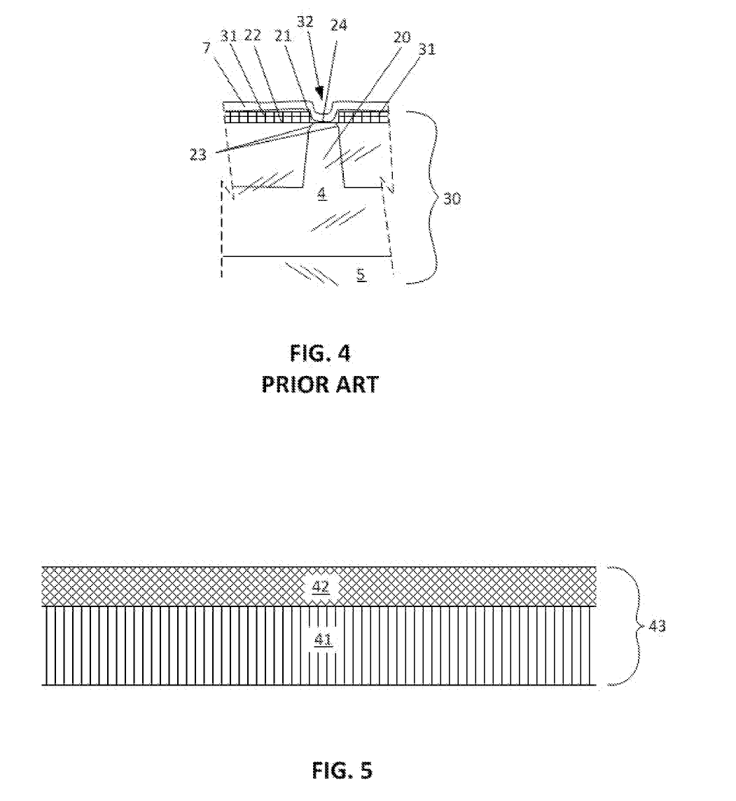

FIG. 4 is the same view of a relief dot 20 produced using a pre-imaged digital (CTP) photopolymer sheet 30, but with most air excluded from the copolymer layer 4 through the use of a vacuum sheet 7 as known in the prior art. When the vacuum is applied prior to UV exposure, the sheet 7 is pulled down into the etched area 32. In a manner similar to that shown in FIG. 2, this greatly reduces, but does not eliminate, gas 21 from being present near the surface 22 of the copolymer 4. Moreover, under high vacuum, any moisture in the image material 31 can evaporate and add to the gas 21. The result is better than that shown in FIG. 3 but roughly the same as FIG. 2.

FIG. 5 is a magnified cross-sectional view of the preliminary laminate 43 used in all three methods of the instant invention. The preliminary laminate consists of a backing sheet 41 coated with a release coating 42. While the inventor has used polyester as a backing sheet in the practice of this invention, the backing sheet 41 may be any smooth, low-porosity material such as many other plastics including polystyrene. Low porosity is essential so that the release coating does not bond tightly to it. The release coating 42 must likewise be formulated not to bond with the backing sheet (for instance, not to soften or chemically etch the backing sheet polymer) but to adhere to it slightly until the backing sheet is ultimately peeled off as discussed further in detail below. The release coating 42 must be inkjet-receptive in the sense that ink droplets from an inkjet printer must adhere to it firmly, but dry on the surface without spreading. A suitable release coating practiced by the inventor is an inkjet-receptive emulsion with no binder additives such as an OSCC clear glossy inkjet-receptive coating. The method of coating the backing sheet 41 requires that the release coating 42 be thin and smooth, as can be produced by curtain coater, a Mayer rod applicator, or a slot-die applicator, to name a few. If the preliminary laminate is to be used to transfer images to a sheet photopolymer, then both layers must be transparent to whatever type of actinic radiation (typically UV) is needed to cause polymerization of the photopolymer.

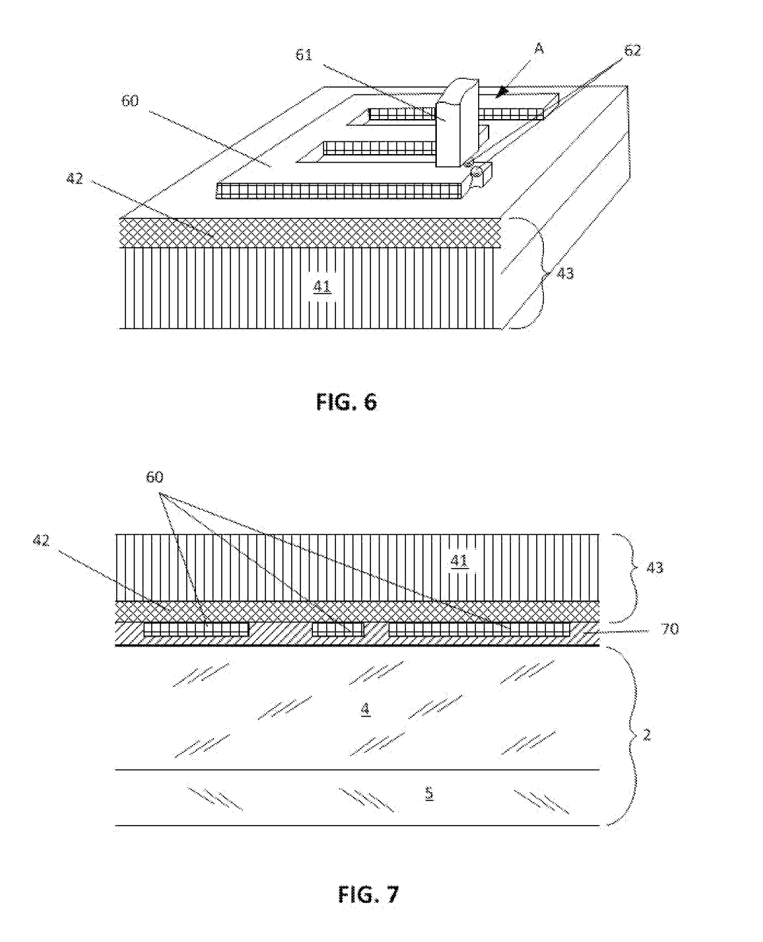

FIG. 6 is a magnified perspective view of a portion of the preliminary laminate 43 being printed with a digital inkjet image 60 in accordance with the first method of the invention. An inkjet print head 61 (typified by that of a water-based piezoelectric printer used to print photopolymer sheets) is moving above and across the release coating 42 in the direction A. As it goes, droplets 62 of UV-opaque ink are discharged onto the release coating 42 according to a computer-generated pattern, forming the UV-opaque negative image 60. The release coating 42 has the purpose of temporarily bonding the inkjet image 60 to the backing sheet 41.

FIG. 7 shows in magnified cross-section the inkjet-printed preliminary laminate 43 from FIG. 6 being applied to an analog sheet photopolymer 2 to produce the first laminate of the invention. This first laminate is then used to produce a flexo plate in accordance with the first method of the invention. As in FIG. 1, the analog sheet photopolymer 2 consists of a layer of photosensitive copolymer 4 bonded to a transparent polyester substrate 5. An adhesive layer 70 is first applied to the surface of the copolymer layer 4. The imaged preliminary laminate 43 is then inverted and pressed into the adhesive layer 70 to produce the first laminate of the invention (note that the backing sheet 41 is uppermost in this view). Importantly, again, the adhesive chosen must bond the inkjet image 60 to the copolymer 4 more tightly than the release coating 42 is bonded to the backing sheet 41.

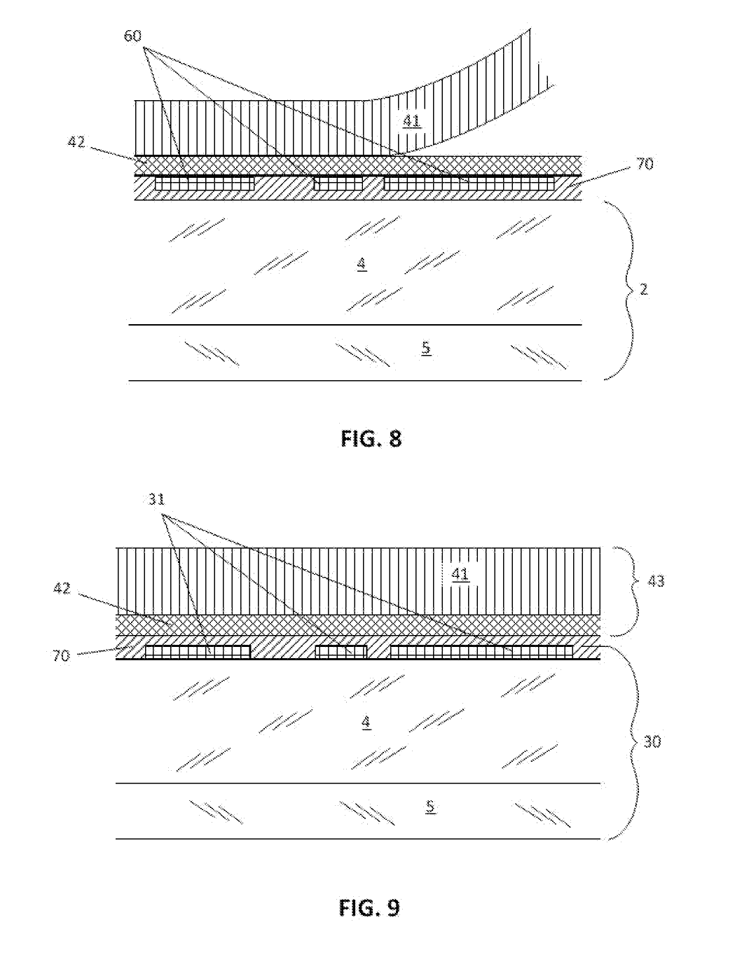

FIG. 8 shows in cross-section the backing sheet 41 being peeled off the unexposed analog sheet photopolymer 2 in accordance with the first method of the invention, leaving behind the release coating 42, the image 60, and the adhesive 70. It is desirable to do this before the UV exposure because any gases that might be generated by the heating of the materials under the lights might otherwise be trapped under the backing sheet.

FIG. 9 is a magnified cross-section of the preliminary laminate 43 from FIG. 5 being applied to a digital (CTP) sheet photopolymer 30 in accordance with the second method of the invention. In this second method, no image is printed on the preliminary laminate 43 as in FIG. 6. Rather, an opaque image 31 is created on the digital sheet photopolymer 30 by ablation of its image coating, or thermal layer, using an IR laser or similar method. Thus, this figure differs from FIG. 7 simply in that the image 31, being part of the sheet photopolymer 30, is in direct contact with the surface of the photosensitive copolymer 4 instead of the release coating 42. So, while the role of the preliminary laminate 43 here does not include transferring the image, its critical role still is to provide an anaerobic and bubble-free condition at the uncoated surface of the photosensitive copolymer 4.

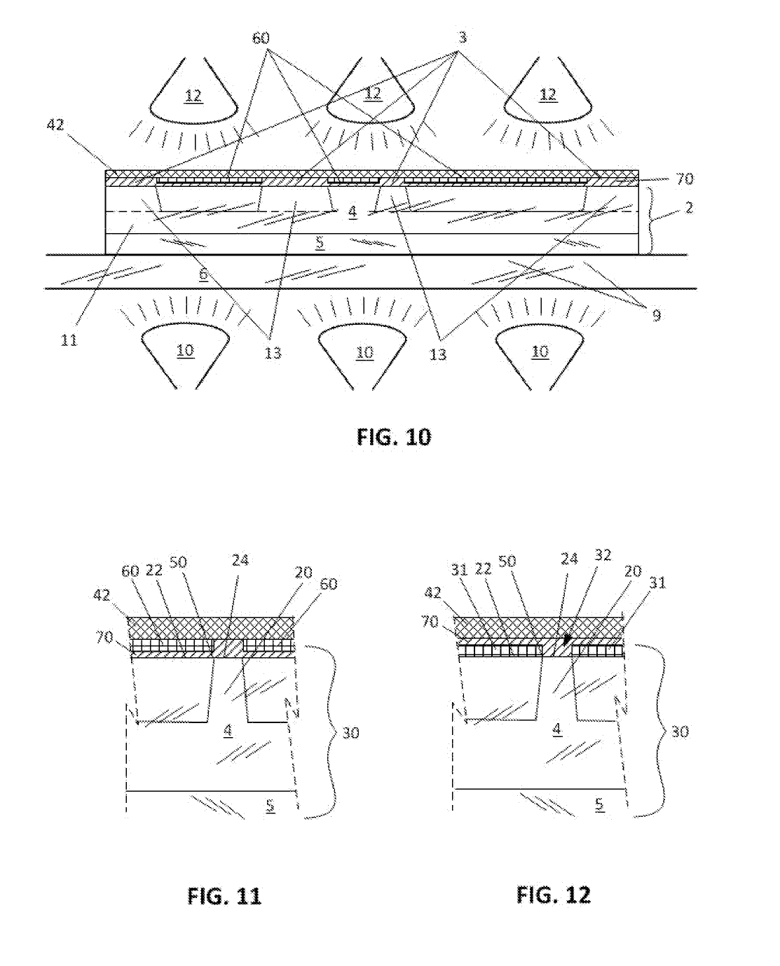

FIG. 10 shows in magnified cross-section an analog photopolymer sheet as prepared in FIG. 8 being exposed to UV light in accordance with the first method of the invention. (This same procedure can be applied to the CTP photopolymer sheet sealed with the preliminary laminate as shown in FIG. 9 once the backing sheet 41 has been peeled off, in accordance with the second method of the invention.) The process is similar to, but simpler than, that shown in FIG. 1. Here, the imaged sheet photopolymer 2 is placed on a transparent bottom glass 6. Lower UV lights 10 are turned on for a length of time sufficient to cure a floor area 11 partway up within the photopolymer from the substrate 5. The upper UV lights 12 are then turned on to shine through the transparent areas 3 in the image layer 1. The lights are on for a length of time sufficient to expose areas within the remainder of the copolymer 4 and create the relief pattern 13. The exposed sheet photopolymer 2 is then developed into a flexo plate by washing and/or scrubbing to remove any unpolymerized photopolymer. Hence it is not sufficient merely to provide an adhesive 70 that will bond the image 60 to the copolymer layer 4 more tightly than the release coating 42 bonds the image 60 to the backing sheet 41. It is also necessary that the image 60 and the adhesive 70 be removable from the optically crosslinked portion of the copolymer layer 4 by the process normally used to develop a relief image. The typical process of solvent washing and scrubbing suitably removes the adhesive layer 70, the image 60 and the release coating 42 along with the uncrosslinked photopolymer.

FIG. 11 is a magnified view of a relief dot 20 produced using the first laminate of the invention as shown in FIG. 7 and prepared in accordance with the first method of the invention. The release coating 42 and the layer of adhesive 70 keep air away from the surface 22 of the copolymer 4. The top 24 of the dot 20 is formed all the way up to the edge 50 of the inkjet-printed area 60 and is therefore flat. The printed image of the dot will be sharp and round. Thus, this first laminate and first method of the invention produce flat top dots of a quality unique to current digital flexo printing plates. This dot shape enables printers to improve substantially their print quality and consistency and increases the print life of the plate, making flexo competitive with gravure and offset printing processes.

FIG. 12 is a highly magnified view of a relief dot 20 produced using the second laminate of the invention as shown in FIG. 9 according to the second method of the invention. The release coating 42 and the layer of adhesive 70 keep air away from the surface 22 of the copolymer 4. However water vapor liberated from the image material 31 by heat from the exposure lamps (not shown) diffuses upward through the adhesive 70 and the release coating 42 and into the ambient air. The top 24 of the dot 20 is formed all the way up to the edge 50 of the etched area 32 and is therefore flat. The printed image of the dot will be sharp and round. The second laminate of the invention produces flat top dots of a quality unique to current digital flexo printing plates. This dot shape enables printers to improve substantially their print quality and consistency and increases the print life of the plate, making flexo competitive with gravure and offset printing processes.

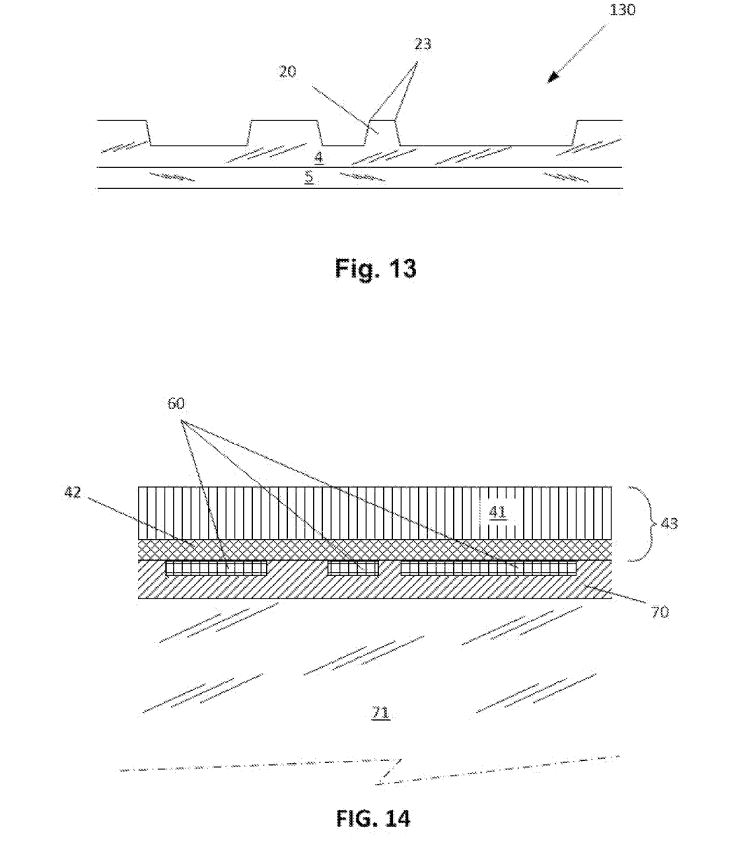

FIG. 13 depicts in cross-section a portion of the finished flexo plate 130 after conventional washing and scrubbing, leaving the photopolymerized portions of the copolymer layer 4 supported by the substrate 5. Note that because the laminates of the invention have isolated the photopolymer sheet from oxygen during curing, the relief dot 20 has sharp shoulders 23.

In summary, the steps of the first method of the invention for making a flexo plate from an inkjet image are: (a) preparing a preliminary laminate by coating a flexible backing sheet with a release coating; (b) printing a mask image on the release coating; (c) coating the active surface of a photopolymer sheet with an adhesive; (d) rolling the image-bearing preliminary laminate onto the adhesive, image side down, so that there are no visible air bubbles under the image; (e) when the adhesive sets, peeling the backing sheet away from the release coating, leaving the release coating and the mask image adhesively bonded to the photopolymer sheet; (f) exposing the masked photopolymer to actinic radiation sufficient to produce the desired cured relief image; and (g) washing the mask image, adhesive, release coating and unexposed photopolymer off the photopolymer substrate and doing any other post-exposure processing as required. Step (c) may alternatively be coating the mask image with adhesive instead of the active surface of the photopolymer sheet. It is possible to get the same result, of course, by applying the adhesive to the image side of the preliminary laminate instead of the photopolymer sheet.

Because the image-bearing preliminary laminate used in the above method is adhesively bonded to the photopolymer, there are no air spaces such as would be attendant to the use of a film negative, and, so long as the preliminary laminate is carefully applied to the photopolymer sheet, there is no ambient air in contact with the photopolymer during curing (the process is anaerobic). Any water vapor given off by the image material will diffuse away from the photopolymer into the ambient air. It is therefore not necessary to put it and the photopolymer sheet under vacuum prior to exposure. This allows the use of a simpler, less expensive unit for the UV exposure and eliminates the steps of positioning a negative film, applying a vacuum sheet, creating a vacuum to remove gases, and removing the negative film after exposure of the photopolymer sheet.

The steps of the second method of the invention for making a flexo plate from a digital image are: (a) preparing a preliminary laminate by coating a flexible backing sheet with a release coating; (b) ablating a mask image into the thermal layer of a digital photopolymer sheet; (c) coating the imaged thermal layer with an adhesive; (d) rolling the preliminary laminate onto the adhesive so that there are no visible air bubbles under the image; (e) when the adhesive sets, peeling the backing sheet away from the release coating, leaving the release coating and the mask image bonded to the photopolymer sheet; (f) exposing the masked photopolymer to actinic radiation sufficient to produce the desired cured relief image; and (g) washing the mask image, adhesive, release coating and unexposed photopolymer off the photopolymer substrate and doing any other post-exposure processing as required. Step (c) may alternatively be coating the release coating with adhesive instead of the imaged thermal layer of the photopolymer sheet.

FIG. 14 depicts in magnified cross-section an example of the third method of the invention for applying an inkjet-printed preliminary laminate 43 from FIG. 6 to transfer its inkjet image 60 to a pane of glass 71. First, an adhesive layer 70 is applied to the surface of the glass 71 (or the inkjet-printed surface of the preliminary laminate). The preliminary laminate with the image is then inverted and pressed into the adhesive layer 70 (note that the backing sheet 41 is uppermost in this view). Importantly, the adhesive chosen must bond the image to the glass more securely than the release coating 42 bonds to the backing sheet 41. An example of an adhesive that works successfully to bond an image to glass, where the backing sheet of the preliminary laminate is polyester and the inkjet ink is water-based, is ethyl-cyanoacrylate glue (“superglue”). Ethyl-cyanoacrylate glue polymerizes very quickly, allowing enough time to coat the glass and seat the imaged preliminary laminate on it, without etching, dissolving or distorting the image. In the actual practice of transferring an image to glass, the choice of ink would likely be water-insoluble as most imaged glass surfaces are likely at least to come into contact with condensate from the atmosphere at some point in time.

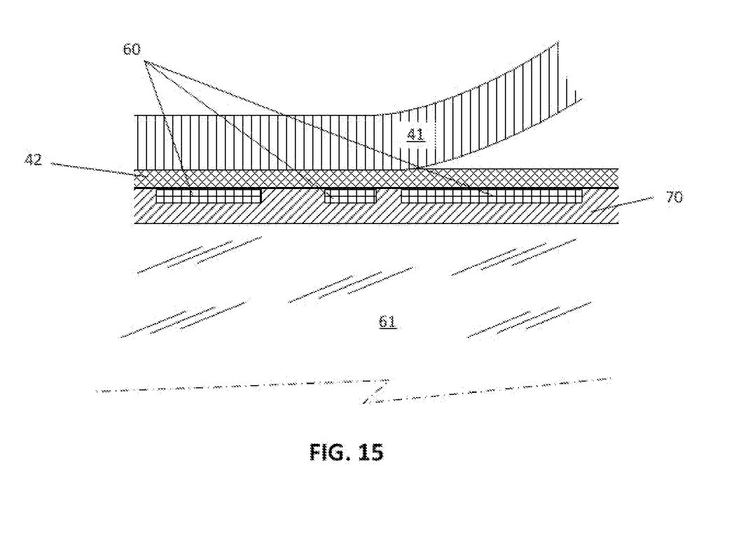

FIG. 15 depicts in cross-section removal of the backing sheet 41 from the release coating 42 in accordance with the third method of the invention. The release coating 42 bonds to the backing sheet 41 with less peel strength than it bonds to the image 60 and adhesive 70. Thus, once the adhesive 70 cures, the backing sheet 41 may be peeled off the release coating 42 as shown, leaving the image on the glass. Because the release coating is clear, it does not matter that it remains on the image. The aforementioned clear glossy inkjet-receptive coating produced by Ontario Specialty Coatings Corporation is water soluble, so that if the ink is insoluble, the release coating 42 may be wiped off with a damp cloth.

1. A laminate, comprising:
(a) a release coating;
(b) an image opaque to actinic radiation;
(c) an adhesive layer;
(d) a photopolymer layer; and
(e) a substrate.

2. The laminate of claim 1, further comprising:
a backing layer adhering to said release coating opposite said image.

3. The laminate of claim 2, in which:
said image is inkjet-printed on the release coating.

4. The laminate of claim 3, in which:
said layers (e) and (f) are layers of a sheet photopolymer.

5. The laminate of claim 2, in which:
said release coating is a clear glossy inkjet-receptive coating; and
said adhesive layer is a cyanoacrylate glue.

6. The laminate of claim 5, in which:
said backing sheet is polyester; and
said clear glossy inkjet-receptive coating has no binder additives.

7. The laminate of claim 2, in which:
said backing sheet adheres to said release coating with less peel strength than said image adheres to said photopolymer layer.

8. A laminate, comprising:
(a) a release coating;
(b) an adhesive layer;
(c) an imaged digital photopolymer sheet.

9. The laminate of claim 8, further comprising:
a backing layer adhering to said release coating opposite said adhesive layer.

10. The laminate of claim 9, in which:
said release coating is a clear glossy inkjet-receptive coating; and
said adhesive layer is a cyanoacrylate glue.

11. The laminate of claim 9, in which:
said backing sheet is polyester; and
said clear glossy inkjet-receptive coating has no binder additives.

12. The laminate of claim 11, in which:
said backing sheet adheres to said release coating with less peel strength than said release coating adheres to said imaged digital photopolymer sheet.

13. A method of making a flexo plate, comprising the steps of:
(a) applying a release coating to a backing sheet;
(b) printing an image on the release coating, creating a release coating image side;
steps (c) and (d), taken from the list of:
(c) applying an adhesive layer to the image side of a sheet photopolymer;
(d) applying the release coating image side to the adhesive layer; or
(c) applying an adhesive layer to the release coating image side, creating a release coating adhesive side;
(d) applying the release coating adhesive side to the image side of a sheet photopolymer;
(e) allowing the adhesive layer to cure;
(f) peeling the backing sheet away from the release coating to produce a printed sheet photopolymer;
(g) exposing the printed sheet photopolymer to actinic radiation; and
(h) cleaning the ink, release coating, adhesive, and un-crosslinked photopolymer off the exposed printed sheet photopolymer.

14. The method of claim 13, in which:
said image is an inkjet image;
said release coating is a clear glossy inkjet-receptive coating with no binder additives;
said backing sheet is polyester; and
said adhesive is a cyanoacrylate glue.

15. The method of claim 13, in which:
said backing sheet adheres to said release coating with a first peel strength;
said release coating adheres to said image with a second peel strength; and
said release coating adheres to said cured adhesive with a third peel strength;
the first peel strength being less than the second peel strength and the third peel strength.

16. A method of making a flexo plate, comprising the steps of:
(a) applying a release coating to a flexible backing sheet;
(b) creating an etched image in the thermal layer of a digital photopolymer sheet;
steps (c) and (d), taken from the list of:
(c) applying an adhesive layer to the thermal layer side of the photopolymer sheet;
(d) applying the release coating to the adhesive layer; or
(c) applying an adhesive layer to the release coating, creating a release coating adhesive side;
(d) applying the release coating adhesive side to the thermal layer side of the photopolymer sheet;
(e) allowing the adhesive layer to cure;
(f) peeling the backing sheet away from the release coating to produce an unexposed sheet photopolymer;
(g) exposing the unexposed sheet photopolymer to actinic radiation; and
(h) cleaning the thermal layer, release coating, adhesive, and un-crosslinked photopolymer off the exposed sheet photopolymer.

17. The method of claim 16, in which:
said release coating is a clear glossy inkjet-receptive coating with no binder additives;
said flexible backing sheet is clear polyester; and
said adhesive is a cyanoacrylate glue.

18. The method of claim 16, in which:
said backing sheet adheres to said release coating with a first peel strength;
said release coating adheres to said thermal layer with a second peel strength; and
said release coating adheres to said cured adhesive with a third peel strength;
the first peel strength being less than the second peel strength and the third peel strength.

19. A method of transferring an image to a surface, comprising the steps of:
(a) applying a release coating to a flexible backing sheet;
(b) applying an image to the release coating, creating a release coating image side;
steps (c) and (d), taken from the list of:
(c) applying an adhesive layer to a surface;
(d) applying the release coating image side to the adhesive layer; or
(c) applying an adhesive layer to the release coating image side, creating a release coating adhesive side;
(d) applying the release coating adhesive side to the surface;
(e) allowing the adhesive layer to cure; and
(f) peeling the backing sheet away from the release coating.

20. The method of claim 19, in which:
said release coating is a clear glossy inkjet-receptive coating with no binder additives;
said flexible backing sheet is polyester; and
said adhesive is a cyanoacrylate glue.

21. The method of claim 19, in which:
said backing sheet adheres to said release coating with a first peel strength;
said release coating adheres to said image with a second peel strength; and
said release coating adheres to said cured adhesive with a third peel strength;
the first peel strength being less than the second peel strength and the third peel strength.
